(19) United States
(12) Patent Application Publication
(10) Pub. No.: US 2021/0140711 A1
(43) Pub. Date: May 13, 2021

(54) FULLY AUTOMATIC REFRACTORY SPRAYING ROBOT WITH MEASUREMENT SYSTEM

(71) Applicant: PIROMET PIROMETALURJI MALZEME REFRAKTER MAKINA SANAYIVE TICARET ANONIM SIEKETI, Dilovasi, Kocaeli (TR)

(72) Inventor: Mustafa ÇONOSOGLU, Dilovasi, Kocaeli (TR)

(21) Appl. No.: 17/045,827

(22) PCT Filed: May 23, 2018
(86) PCT No.: PCT/TR2018/050261

§ 371 Date: Oct. 7, 2020

(51) Int. Cl. F27D 1/16; F27D 21/00; B25J 11/00; B25J 15/00; B25J 15/02; B25J 13/08; B25J 9/02

(52) U.S. Cl. CPC F27D 1/1642; F27D 21/0021; B25J 11/0075; B25J 9/023; B25J 15/02; B25J 13/088; B25J 15/0019

(57) ABSTRACT

A refractory spraying robot in iron steel production plants, detecting the worn areas of the units such as arc furnace, induction furnace, converter, ladles and other similar units, due to fluid steel effects, by a measurement instrument, processing the obtained data by PLC and mapping the worn faulty sections automatically, transferring the discovered coordinates to a spraying head and performing fully automatic repair work by spraying refractory materials onto the faulty sections without human touch.

### THE RELATED ART

The invention relates to a refractory spraying robot providing repair of refractories in units worn by effects of fluid steel in arc furnace, induction furnace, converter, ladles and other similar things in iron steel production plants by means of spraying mortar materials.

The invention particularly relates to refractory spraying robot detecting the worn areas of the furnace by means of a measurement instrument processing the obtained data by means of PLC and mapping the worn sections and transferring the estimated coordinates to spraying head and thus performing fully automatic repair work by spraying refractory materials onto faulty sections without man touching.

### PRIOR ART

In the prior art, refractory bricks of various types depending on places of use are particularly used in iron steel and casting sectors where treatments are conducted at very high temperatures. Due to wearing in refractory bricks used in high temperature furnaces employed for melting and processing mostly metals, repair is needed. Failure to repair faulty sections will lead to major risks during working. Upon start of extreme heating locally, fluid steel may cause hole in the place where it is and may result in death and big material loss involving work accidents. It is needed to wait for cooling down of the furnace or ladles in order to replace the worn or danger exposing bricks or bricks groups. This period is not only long but also causes big production loss. Determination of worn sections can only be conducted visibly. Internal sections of steel production units such as furnace/converters/ladles have restricted access. Since it is needed to approach the faulty sections considerably in order to repair, it constitutes big danger. Additional time is needed to observe the faulty sections. In competitive environment of today, it is an unbearable loss for steel producers. For that reason, it is required to determine worn sections without cooling down the furnace or pots and not visibly but automatically and to repair them with minimum production loss and to resume the production.

Repair implementations conducted without use of robots is made by use of equipment called gunning machine. Gunning machines' working principle is similar to working principle of sandblasting machines. Mortar materials compressed in a pressure vessel are applied by means of supplying them through a hose connected to tank outlet. Dry mortar material is mixed with water inside a pipe connected to hose end and then sprayed. Spraying pipe is a heavy and bulky equipment that even two men hardly lift and carry it. Furthermore, holding the spraying pipe by operators to apply is highly risky in terms of occupational safety (injuries and even life loss may be encountered due to temperature effect). Spraying applications made gropingly can be made maximum at 2-3 bars pressure. Holding hose by operators becomes more difficult in case of applications under higher pressures due to too much vibration of spraying pipe. In robotic applications, air pressure can be 5-6 bars and event higher thanks to rigidity of the system. Final strength of gropingly conducted spraying repair applications at 2-3 bars is less than the ones made by robot. Such case requires more frequent repair for furnace or pot and increases cost and causes production loss.

During patent search made regarding the subject matter, patent application numbered TR201201106 was found. The invention is a refractory spaying robot (horizontal inlet) for steel production plants. Abstract of the invention reads as: “Invention includes a refractory spraying robot (horizontal) for steel production plants, used in applications where it is possible to repair worn refractories by impacts of fluid steel such as arc furnace, induction furnace, converter, ladles and other similar things by use of spraying mortar materials.”

The application numbered TR201110086 relates to refractory spraying robot (vertical inlet) for steel production plants. Abstract of the invention reads as: “Invention includes a refractory spraying robot for steel production plants, used in applications where it is possible to repair worn refractories by impacts of fluid steel such as arc furnace, induction furnace, converter, pots and other similar things by use of spraying mortar materials and capable to rotate back and forth, up and down and 360 degrees on its own axis.

Another application relating to the subject matter is the application numbered TR200300692. The invention is an electrical arc furnace refractory repair robot. Abstract of the invention reads as: “Invention is a repair robot used for hot repair of arc furnace by means of putting hot repair mortar onto refractory layer in electrical arc furnaces (EAF) by means of spraying gun on the manipulator tip and for taking spraying gun into furnace through side cover consisting of at least an extending pendulum level on one end of which said spraying gun is located, at least a manipulation arm joined on other end of said extending pendulum arm, at least a driving member located between said pendulum arm and manipulation arm and providing motion on the joints of arms and a rotating component whereon one end of said manipulation arm is connected.

When the embodiments whose abstracts are given above and which are used in refractory repair are examined, it is seen that the embodiments do not contain any measurement system to detect the faulty sections of refractory in the furnace.

In conclusion, developments have been made in robotic refractory spraying machines and, therefore, new embodiments eliminating the above disadvantages and offering solutions to existing systems are needed.

### PURPOSE OF THE INVENTION

The present invention relates to refractory spraying robot meeting the needs mentioned above, eliminating all disadvantages and providing some additional advantages.

Main purpose of the invention is to add measurement instrument t refractory spraying robot mechanism, to detect automatically the worn faulty sections of furnace/pot/converter by help of said measurement instrument, to transmit information of detected faulty sections to PLC program and to map it for repair.

Another purpose of the invention is to transfer the data of coordinates of the faulty sections detected by measurement instrument to the spraying head, to spray refractory onto the faulty sections and conduct repair operations fully automatically.

A further purpose of the invention is to provide full automatic detection and repair of refractory faults without man's touch and thus eliminate risk of work accidents and to conduct repair works at higher pressures and faster, more effectively and safely.

In order to achieve all advantages mentioned above and o be understood from the following detailed description, the present invention is a refractory spraying robot providing repair of refractories in units worn by effects of fluid steel in arc furnace, induction furnace, converter, pots and other similar things by means of spraying mortar materials and it comprises;
A measurement device mounting cylinder mounted on vertical axis (Z-axis) on main body,
A measurement device mounted onto upper section of said measurement device mounting cylinder on horizontal axis and providing access to measurement instrument to measurement area,
Measurement instrument mounted on end section of said measurement device, measuring thickness of bricks and thus estimating positions which are required to be repaired and transmitting the obtained data to PLC and thus providing repair of faulty sections by spraying refractory materials by means of spraying head.

The structural and characteristic feature and all advantages of the invention will be understood better in the FIGURE given below and the detailed description by reference to the figures.

### BRIEF DESCRIPTION OF FIGURES

In order to make the embodiment and the advantages of the invention clearer for better understanding, it should be assessed with reference to the following described FIGURE.

FIG. 1: is a three-dimension view of refractory spraying robot of this invention.

### REFERENCE NUMBERS

1. Refractory Spraying Robot

2. Main Body

3. Spraying Arm

4. Spraying Arm Tower

5. Spraying Arm Rotating Joint

6. Spraying Arm Rotating Mechanism

7. Spraying Arm Lifting Cylinder

8. Spraying Head

9. Material Transferring Pipe

10. Measurement Instrument

11. Measurement Device

12. Measurement Device Mounting Cylinder

13. Measurement Device Rotating Joint

14. Measurement Device Rotating Mechanism

15. Measurement Device Rotating Mechanism

16. Spraying Nozzle

### DETAILED DESCRIPTION OF THE INVENTION

In this detailed description, the preferred embodiments of the refractory spraying robot (1) being subject of the invention have been described in a manner not forming any restrictive effect and only for purpose of better understanding of the matter.

The invention relates to a refractory spraying robot (1) providing repair of refractories in units worn by effects of molten steel in arc furnace, induction furnace, converter, ladles and other similar things in iron steel production plants by means of spraying mortar materials. Refractory spraying robot (1) consisting of mainly five main sections is a mechanism having high heat resistant, high rigidity and capable to repeatability functions. Refractory spraying robot (1) is in fact an equipment for professional use, designed for heavy industrial conditions and capable to spray refractory mortar materials whose grain size, chemical and physical features are known in advance, to any desired area manually, semi-automatically or full automatically by means of compressed air and water through spraying nozzle (16),

FIG. 1 shows a three-dimension view of a preferred embodiment of the refractory spraying robot (1) disclosed under the invention. According to the FIGURE, the refractory spraying robot (1) is installed on a supporting main body (2). Driving systems of the mechanism and all other components together with arm groups in internal section are mounted in internal section and on said main body (2). A spraying arm tower (4) is mounted on upper part of main body (2) on vertical axis (Z-axis). A spraying arm (3) working on horizontal axis (Y-axis) is mounted to said spraying arm tower (4). Spraying arm (3) and spraying arm tower (4) are interconnected by means of a spraying arm rotating joint (5). Also a spraying arm lifting cylinder (7) is located between the spraying arm (3) and the spraying arm tower (4). Thus spraying arm lifting cylinder (7) driving and spraying arm (3) complete rotate on axis of spraying arm rotating joint (5) (X-axis) and can move up and down. Spraying arm rotating mechanism (6) is located on the section where the spraying arm tower (4) is connected to the main body (2). Spraying arm (3) is capable to rotate at 360 degrees on vertical axis (Z-axis) of spraying arm (3) by means of spraying arm rotating mechanism (6) driven by servo motors.

Spraying head (8) is mounted on end part of the spraying arm (3). Spraying head (8) carried by spraying arm (3) is the unit providing compressed spraying of the refractory material through a spraying nozzle (16) located on lower end. A material transferring pipe (9) is connected to the spraying head (8). The material transferring pipe (9) extends from the main body (2) to spraying arm (3) and is connected to the spraying head (8).

Main novelty disclosed in the refractory spraying robot (1) of the invention is a measurement instrument (10) integrated to the spraying robot (1). For mounting said measurement instrument (10) to the main body (2), a measurement device mounting cylinder (12) is mounted on the upper section of the main body (2) and a measurement device (11) extending to said measurement device mounting cylinder (12) in horizontal axis in respect to ground is mounted. Measurement instrument (10) is mounted on end section of the measurement device (11).

Measurement device rotating mechanism (14) is located on the section where the measurement device mounting cylinder (12) is connected to the main body (2). Said measurement device rotating mechanism (14) is capable to rotate complete measurement device (11) 360 degrees on vertical axis (Z-axis). Measurement device rotating mechanism (14) is driven by servo motors. The measurement device (11) and the measurement device mounting cylinder (12) are interconnected by means of measurement device rotating joint (13). Measurement device rotating mechanism (15) is mounted between measurement device (11) and the measurement device mounting cylinder (12). Measurement instrument (10) on the end of the measurement device (12) and the measurement device (12) is capable to move up and down on the axis of the measurement device rotating joint (13) by means of the measurement device rotating mechanism (15) working on vertical axis.

Working principle of the refractory spraying robot (1) disclosed under the invention is as follows:

Up and down motion of spraying arm lifting cylinder (7) providing up-down motion of the spraying arm (3) is provided by help of proportional valves. Thus up and down motion of spraying arm (3) and spraying head (8) at gradual speeds can be conducted. Speed of motions of the spraying arm (3) and spraying head (8) is adjusted by PLC programming. Similarly, motion of spraying arm rotating mechanism (6) providing rotation of complete spraying arm (3) 360 degrees on Z axis and driven by servo motors in the main body (2) is controlled by help of PLC.

The main body (2) also has pneumatic board and required adjustments of air and water lines from network for refractory spraying robot (1) are executed by means of said pneumatic board. The main body (2) also has lubrication pump executing lubrication of the refractory spraying robot (1). All of the moving mechanism parts are lubricated by help of distributors located at certain intervals independent of operation of the refractory spraying robot (1) via automatic lubrication system provided on the refractory spraying robot (1). In case the pump is out of order, the system warns operator visually and in writing.

The main body (2) contains a water pump with flow control by frequency converter in order to provide mixture of dry mortar material with water.

The refractory spraying robot (1) also has water dosing system. Said dosing system consists of a water pump with a frequency converter, a water adjustment valve with electro pneumatic flow rate control, an electronic flow rate measurement device of high accuracy and a high performance water mixture nozzle. Quantity of water to be put into the system is estimated based on spraying materials prescription (for instance 10% water or 20 kg/min). The system measures water flow rate very accurately before water mixture nozzle and adjusts the water pump with frequency converter and water valve with electrical flow rate control according to proper flow control methods (PID), and thus sets out the required water level. Thus, the operators do not loose time for water adjustment while performing manual or automatic refractory repairs.

The refractory spraying robot (1) disclosed under the invention also has an air fluid cooling system. Control valves of the cooling system are located in pneumatic board in lower part of the main body (2). Cooling system contains air nozzles cooling the spraying arm (3) and spraying head (8). As soon as the refractory spraying robot (1) is started, air nozzles are activated and start to cool down the refractory spraying robot (1). When temperature goes over the set out values, the system warns operator. Said air nozzles are activated and provide cooling down when the temperature in the related areas is above adjusted maximum temperature even if when the robot is not in operation.

Thickness of the bricks laid inside furnace/pot/converted is measured by help of measurement device (11) connected onto the main body (2) by measurement device mounting cylinder (12), and measurement instrument (10) and positions needing repair works are transmitted to PLC. PLC collects convenient coordinates and runs spraying arm (3) and spraying head (8) synchronously and sprays required quantity of material to the proper areas. Thus the refractory spraying robot (1) performs repair works full automatically. Measurement instrument (10) driving system is driven by 2 servo motors on Y axis and 1 servo motor on Z-axis.

Spraying head (8) and spraying nozzle (16) are the parts that go into the furnace and perform the spraying operation. Spraying head (8) is capable to rotate 360 degrees on Z-axis. Thus it can be rotated in the desired direction as much as required. Rotation of the spraying head (8) is driven by 1 servo motor. Measurement device rotating mechanism (15) providing motion on Y-axis consists of preferably 2 servo motors and a linear actuator. Mixture of refractory repair material with water is made inside spraying head (8).

Thanks to measurement instrument (10) integrated to refractory spraying robot (1) disclosed under the invention, the detection of worn faulty sections of furnace/ladles/converter as described above and automatic performance of repairs without touch of man has been enabled. Thus the work accident risks are eliminated, repair works can be performed at higher pressures, faster, more effective and safely.

1. A refractory spraying robot in order to repair refractories in units worn by effects of fluid steel in arc furnace, induction furnace, converter, ladles and other similar things by means of spraying mortar materials and comprising a main body containing all components of the mechanism, a spraying arm tower located in a vertical position on upper section of said main body, a spraying arm mounted onto said spraying arm tower in vertical position, a spraying arm rotating joint connecting said spraying arm and the spraying arm tower, a spraying head mounted in end section of the spraying arm and spraying refractory material by means of spraying nozzle, a spraying arm rotating mechanism providing rotation of the spraying arm on vertical axis (Z axis) at 360 degrees, a spraying arm lifting cylinder providing up and down motion of the spraying arm and material transferring pipe characterized by comprising;
at least a measurement device mounting cylinder mounted on vertical axis (Z-axis) on the main body;
at least a measurement device mounted onto upper section of said measurement device mounting cylinder on horizontal axis and providing measurement instrument to access measurement area;
at least a measurement instrument mounted on end section of said measurement device, measuring thickness of bricks and thus estimating positions which are required to be repaired and transmitting the obtained data to PLC and thus providing repair of faulty sections by spraying refractory materials by means of spraying head.

2. A refractory spraying robot according to claim 1, comprising; a measurement device rotating joint connecting the measurement device and measurement device mounting cylinder in an articulated manner.

3. A refractory spraying robot according to claim 1, comprising; a measurement device rotating mechanism providing rotation of the measurement device mounting cylinder 360 degrees on vertical axis (Z axis).

4. A refractory spraying robot according to claim 1, comprising; a measurement device rotating mechanism mounted between measurement device and the measurement device mounting cylinder and providing up-down motion of the measurement device.
